(19) United States
(12) Patent Application Publication
(10) Pub. No.: US 2022/0229870 A1
(43) Pub. Date: Jul. 21, 2022

(54) SELF ADJUSTING DASHBOARDS FOR LOG AND ALERT DATA

(71) Applicant: VMWARE, INC., Palo Alto, CA (US)

(72) Inventors: SANJAY CHAUDHARY, San Jose, CA (US); AMEYA VIVEK BAPORIKAR, Bangalore (IN); CHAITANYA KRISHNA MULLANGI, Bangalore (IN)

(21) Appl. No.: 17/212,052

(22) Filed: Mar. 25, 2021

(30) Foreign Application Priority Data
Jan. 21, 2021 (IN) 202141002994

(51) Int. Cl. G06F 16/904; G06N 20/00; G06F 3/0486

(52) U.S. Cl. CPC G06F 16/904; G06F 3/0486; G06N 20/00

(57) ABSTRACT

The disclosure provides an approach for data visualization. Embodiments include receiving user input requesting a visualization, wherein the user input identifies one or more entities selected from: a query; an alert; or a widget. Embodiments include providing one or more inputs to a machine learning model based on the user input, wherein the machine learning model has been trained based on historical visualization data. Embodiments include determining, based on an output received from the machine learning model in response to the one or more inputs, a visualization type for the visualization. Embodiments include generating the visualization based on the visualization type and the one or more entities. Embodiments include displaying the visualization via a user interface.

### RELATED APPLICATIONS

Benefit is claimed under 35 U.S.C. 119(a)-(d) to Foreign Application Serial No. 202141002994 filed in India entitled “SELF ADJUSTING DASHBOARDS FOR LOG AND ALERT DATA”, on Jan. 21, 2021, by VMware, Inc., which is herein incorporated in its entirety by reference for all purposes.

### BACKGROUND

Services running in a network generate large amounts of data, such as logs and alerts. This data may be analyzed, such as by administrators, for a variety of purposes, such as to monitor the health of services, track resource usage, identify sources of problems, and the like. However, due to the large volume of data that may be generated, it can be difficult to identify significant and relevant information.

In some cases, visualizations may be generated to aid in analyzing data. For example, an administrator may request a chart or graph representing a subset of data generated by services. In existing techniques, an administrator must determine a type of visualization that is likely to be most useful in analyzing a given type of data. Furthermore, existing techniques generally require an administrator to request a single visualization at a time. As such, existing techniques may cause an administrator to spend a significant amount of time deciding how best to visualize data and setting up the visualizations for analysis.

Accordingly, there is a need in the art for improved techniques for generating visualizations of data generated by services in a network.

### BRIEF DESCRIPTION OF THE DRAWINGS

FIG. 1 depicts example components related to self-adjusting data visualization.

FIG. 2 depicts example physical and virtual network components with which embodiments of the present disclosure may be implemented.

FIG. 3 depicts example operations for self-adjusting data visualization.

FIG. 4 depicts an example screen of a user interface for self-adjusting data visualization.

FIG. 5 depicts another example screen of a user interface for self-adjusting data visualization.

FIG. 6 depicts another example screen of a user interface for self-adjusting data visualization.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

The present disclosure provides an approach for self-adjusting data visualization. In particular, embodiments include a self-adjusting dashboard for visualizations of log and alert data generated by services in a network.

Techniques described herein involve organizing data generated by services to allow for easy searching, filtering, and grouping of log queries, alert definitions, and existing widgets in a single user interface. In some embodiments, users are enabled to drag and drop log queries and alert definitions, as well as existing widgets, onto a dashboard for convenient creation of a unified view of data visualizations. Widget types are automatically determined for visualizing certain types of log queries and alert definitions, and widgets of the determined widget types are automatically created within the dashboard for data visualization. Multiple widgets may be displayed within the same unified view so that an administrator may conveniently analyze a variety of data sources.

A log query generally refers to a request for a particular subset of data from one or more logs, such as a request for log entries containing a certain keyword or attribute, from a certain time window, created by a certain type of service, having certain values, and/or the like. Log queries may be dynamically defined by a user, automatically determined (e.g., based on historical log queries by one or more users), fixed (e.g., determined in advance), and/or the like. An alert generally refers to an indication issued by a service that a condition has been met, such as a value exceeding a threshold, and may indicate a problem that needs to be addressed. Log and alert data generally comprise text-based data. A widget generally refers to a user interface component that provides a discrete type of functionality, such as a visualization of a particular subset of data. An existing widget is a widget that has been previously created, such as a particular visualization of a particular subset of data, and may be added by a user to a dashboard. A dashboard generally refers to a user interface within which various widgets can be viewed, such as widgets including visualizations of multiple types of data.

According to certain embodiments, historical widget data is used to automatically determine a widget type for a given log query or alert (or set of log queries and/or alerts). In certain embodiments, machine learning techniques are used. For example, a machine learning model may be trained based on historical widgets created by users to visualize particular types of data, and may be used to automatically determine a suitable widget type for visualizing a given set of data.

Existing techniques do not allow for automatic determination of widget types for visualizing given types of data, nor do they provide a convenient user interface in which log queries, alerts, and existing widgets can be dragged and dropped for separate or combined visualization within a single screen. As such, embodiments of the present disclosure improve upon existing techniques by providing a self-adjusting dashboard for displaying multiple visualizations of log and alert data. By automatically determining widget types and generating visualizations for different types of data within a single dashboard, techniques described herein reduce the amount of time and effort required to set up a dashboard for data analysis and improve a user experience by allowing for more efficient and effective data analysis.

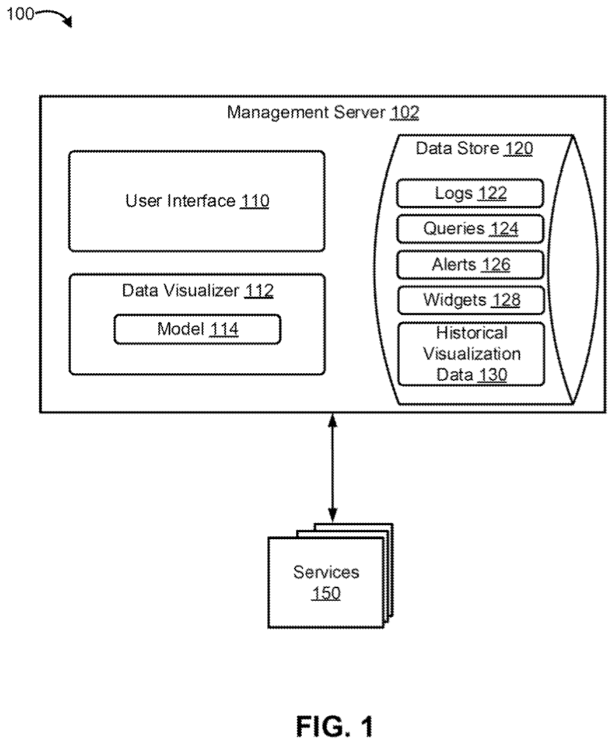

FIG. 1 is an illustration 100 of example components related to self-adjusting data visualization.

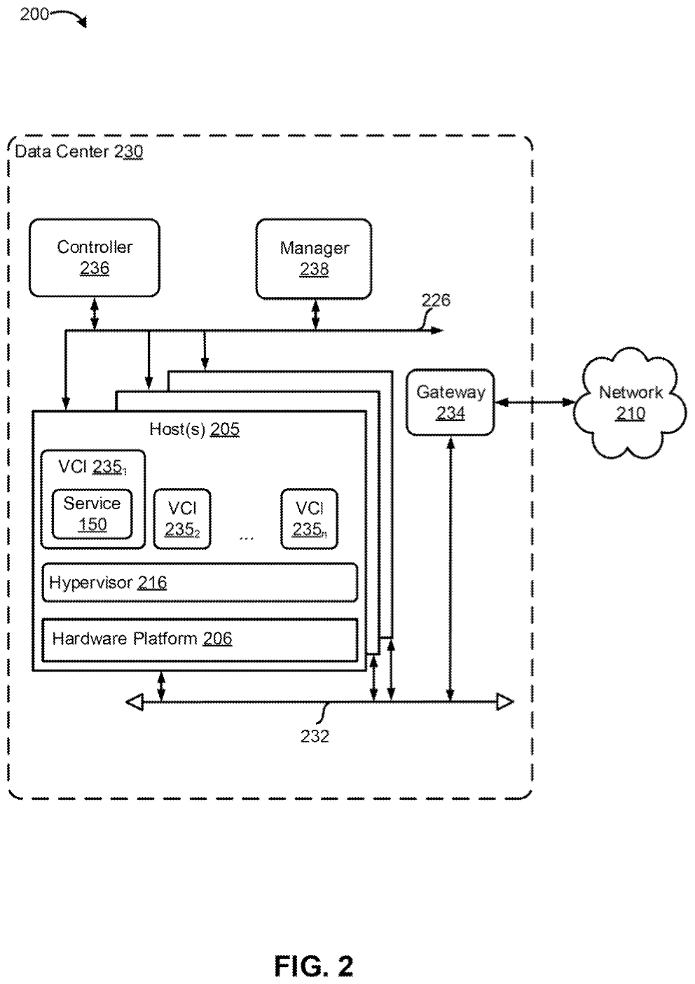

Management server 102 generally represents a computing device, such as a server computer, that performs management functions with respect to one or more services 150 running in a networking environment, such as a physical or virtual networking environment. In one example, as described in more detail below with respect to FIG. 2, management server 102 corresponds to a management plane of a software defined network.

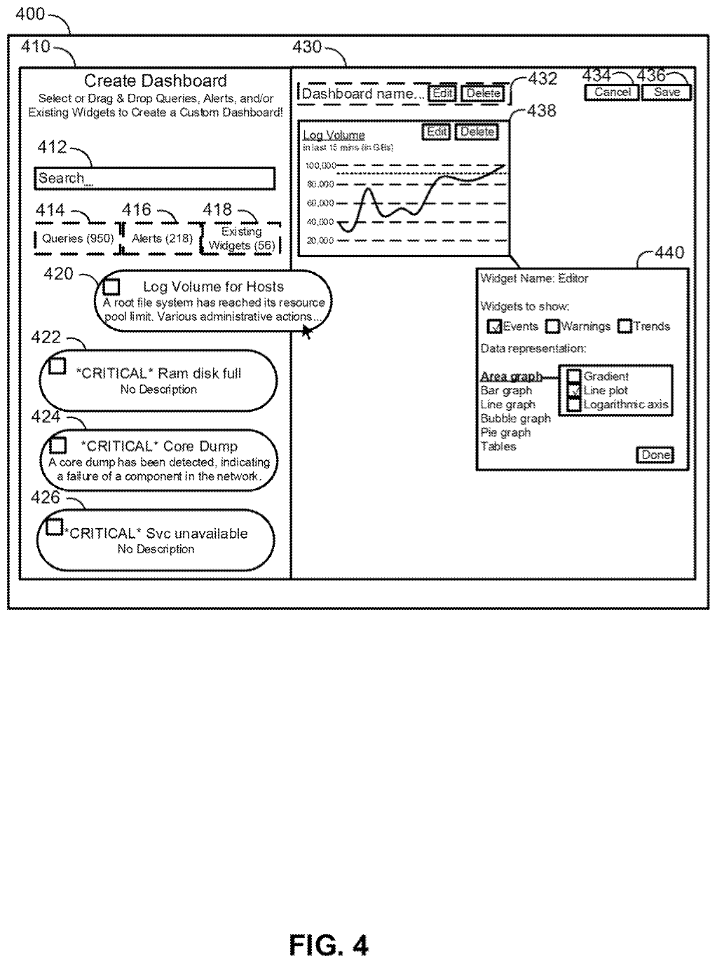

Management server 102 comprises a user interface 110 through which a user configures, views, and provides input with respect to data visualizations generated by data visualizer 112. In some embodiments, user interface 110 provides a user with a panel in which log and alert data can be searched filtered, and grouped for use in generating visualizations. For example, the user may be enabled to drag and drop log queries and alerts from the panel onto a dashboard that displays data visualizations. The panel may also include existing widgets that the user can add to the dashboard. Multiple widgets with visualizations of different sets of data may be displayed and configured by the user within user interface 110 for efficient and effective data analysis. Examples screens of user interface 110 are described below with respect to FIGS. 4-6.

Data visualizer 112 generates widgets for data visualization that can be displayed within user interface 110. In some embodiments, data visualizer 112 receives a request to visualize a certain set of data, such as one or more queries 124 (the queries being for data within logs 122) and/or alerts 126. Data visualizer 112 automatically determines a suitable widget type for visualizing the set of data, such as through the use of model 114.

Model 114 represents a machine learning model that has been trained using historical visualization data 130 to output a widget type in response to inputs describing a set of data. Machine learning techniques generally involve using a set of training inputs and training outputs to build a model that will output a value in response to inputs. Inputs may be described as “features”. For example, each training data instance may include training data inputs or features (e.g., attributes, such as data types, of log queries and/or alerts visualized in historical widgets) associated with a training data output or label (e.g., an indication of the type of widget that was historically used to visualize the log queries and/or alerts). A plurality of training data instances is used to train the model, such as by constructing a model that represents relationships between features and output values. In some embodiments, training involves providing training data inputs to the model and iteratively adjusting parameters of the model until the outputs from the model in response to the training data inputs match (or fall within a certain range of) the training data outputs associated with the training data inputs, or until some condition is met, such as when a certain number of iterations have been completed without significant improvements in accuracy.

For example, model 114 may be trained using a training data set comprising features of past sets of data that were visualized in widgets associated with labels indicating the types of widgets used to visualize the past data sets. Features may include, for example, whether a past set of data includes log queries and/or alerts, the types of data in the past set of data (e.g., log volume data, resource usage data, numbers of connections, inbound and/or outbound traffic records, error rates, or the like), whether the past set of data includes ordered data, whether the past set of data includes a time series of values, the amount of data in the past set of data, and the like. Types of widgets used to visualize sets of data may include, for example, line graphs, area graphs, bar graphs, bubble graphs, pie graphs, tables, scatter plots, textual summaries, and the like.

The trained model may be subjected to testing. Testing generally involves providing datapoints from a test dataset as inputs to the model, receiving labels as outputs, and verifying that the output labels match test labels. In some embodiments, a training data set generated based on past user decisions is split into training data and test data for use in the separate training and testing stages.

Various types of machine learning models known in the art may be utilized with embodiments of the present disclosure, such as a neural network, a decision tree, a random forest, a long short term memory (LSTM) model, a gradient boosting machine, a linear regression model, or the like.

Once trained, model 114 may be provided with features of a set of data for which a visualization is requested and may output a label indicating a widget type to use for visualizing the set of data. The output from model 114 may be used by data visualizer 112 to automatically select a widget type and generate a widget of the widget type with a visualization of the set of data. For example, if historical visualization data 130 indicates that users historically tended to use bar graphs to visualize log queries for numbers of inbound connections per five minute interval, the model 114 may provide output indicating that a bar graph widget should be used to visualize a subsequent log query for similar data. As such, data visualizer 112 may generate a bar graph widget that includes a visualization of the subsequent log query, and the generated bar graph widget may be displayed within a dashboard in user interface 110.

The user may select additional log queries and/or alerts, as well as existing widgets, to add to the dashboard, such as through drag-and-drop input, and additional widgets corresponding to the user's selections are added to the dashboard. In some embodiments, the user is presented with a recommended widget type for a given requested visualization and is allowed an opportunity to approve or modify the recommended widget type. Furthermore, if the user selects more than one log query, alert, or existing widget, the user may be presented with an option to either combine the selected items into a single widget or to have them visualized in separate widgets.

Data store 120 generally represents a data storage entity such as a database or repository. Data store 120 comprises logs 122, which are generated by services 150. Data store 120 further comprises queries 124, which include requests for subsets of data from logs 122, such as historical queries input by users. Data store 120 further comprises widgets 128, which include existing widget generated to visualize data. Data store 120 further comprises historical visualization data 130, which generally includes information about data sets that were previously visualized in widgets, associated with information about the widgets that were used to visualize the data sets, such as the types of widgets.

Services 150 include a variety of different software applications executing in a networking environment. Examples of services include firewalls, load balancers, system health monitoring components, business management applications, machine learning model training applications, and other types of software applications.

FIG. 2 depicts example physical and virtual network components with which embodiments of the present disclosure may be implemented

Networking environment 200 includes a data center 230 connected to network 210. Network 210 is generally representative of a network of computing entities such as a local area network (“LAN”) or a wide area network (“WAN”), a network of networks, such as the Internet, or any connection over which data may be transmitted.

Data center 230 generally represents a set of networked computing entities, and may comprise a logical overlay network. Data center 230 includes host(s) 205, a gateway 234, a data network 232, which may be a Layer 3 network, and a management network 226. Data network 232 and management network 226 may be separate physical networks or different virtual local area networks (VLANs) on the same physical network.

Each of hosts 205 may be constructed on a server grade hardware platform 206, such as an x86 architecture platform. For example, hosts 205 may be geographically co-located servers on the same rack or on different racks. Host 205 is configured to provide a virtualization layer, also referred to as a hypervisor 216, that abstracts processor, memory, storage, and networking resources of hardware platform 106 into multiple virtual computing instances (VCIs) 235₁ to 235ₙ (collectively referred to as VCIs 235 and individually referred to as VCI 235) that run concurrently on the same host. VCIs 235 may include, for instance, VMs, containers, virtual appliances, and/or the like. VCI 235₁ comprises a service 150, which generally represents one of services 150 of FIG. 1. For example, services 150 of FIG. 1 may run on one or more VCIs on hosts 205.

Hypervisor 216 may run in conjunction with an operating system (not shown) in host 205. In some embodiments, hypervisor 216 can be installed as system level software directly on hardware platform 206 of host 205 (often referred to as “bare metal” installation) and be conceptually interposed between the physical hardware and the guest operating systems executing in the virtual machines. In certain aspects, hypervisor 216 implements one or more logical entities, such as logical switches, routers, etc. as one or more virtual entities such as virtual switches, routers, etc. In some implementations, hypervisor 216 may comprise system level software as well as a “Domain 0” or “Root Partition” virtual machine (not shown) which is a privileged machine that has access to the physical hardware resources of the host. In this implementation, one or more of a virtual switch, virtual router, virtual tunnel endpoint (VTEP), etc., along with hardware drivers, may reside in the privileged virtual machine. Although aspects of the disclosure are described with reference to VMs, the teachings herein also apply to other types of virtual computing instances (VCIs) or data compute nodes (DCNs), such as containers, which may be referred to as Docker containers, isolated user space instances, namespace containers, etc. In certain embodiments, VCIs 235 may be replaced with containers that run on host 205 without the use of a hypervisor. Further, though certain aspects are described with respect to VCIs, such aspects may similarly apply to physical computing devices. For example, services 150 may run on a physical server.

Gateway 234 provides VCIs 235 and other components in data center 230 with connectivity to network 210, and is used to communicate with destinations external to data center 230 (not shown). Gateway 234 may be implemented as one or more VCIs, physical devices, and/or software modules running within one or more hosts 205.

Controller 236 generally represents a control plane that manages configuration of VCIs 235 within data center 230. Controller 236 may be a computer program that resides and executes in a central server in data center 230 or, alternatively, controller 236 may run as a virtual appliance (e.g., a VM) in one of hosts 205. Although shown as a single unit, it should be understood that controller 236 may be implemented as a distributed or clustered system. That is, controller 236 may include multiple servers or virtual computing instances that implement controller functions. Controller 236 is associated with one or more virtual and/or physical CPUs (not shown). Processor(s) resources allotted or assigned to controller 236 may be unique to controller 236, or may be shared with other components of data center 230. Controller 236 communicates with hosts 205 via management network 226.

Manager 238 represents a management plane comprising one or more computing devices responsible for receiving logical network configuration inputs, such as from a network administrator, defining one or more endpoints (e.g., VCIs and/or containers) and the connections between the endpoints, as well as rules governing communications between various endpoints. In one embodiment, manager 238 is a computer program that executes in a central server in networking environment 200, or alternatively, manager 238 may run in a VM, e.g. in one of hosts 205. Manager 238 is configured to receive inputs from an administrator or other entity, e.g., via a web interface or API, and carry out administrative tasks for data center 230, including centralized network management and providing an aggregated system view for a user. For example, manager 238 may correspond to management server 102 of FIG. 1. According to embodiments of the present disclosure, manger 238 allows a user to select log queries, alerts, and exiting widgets for addition to a unified dashboard in which widgets are automatically created to visualize selected data.

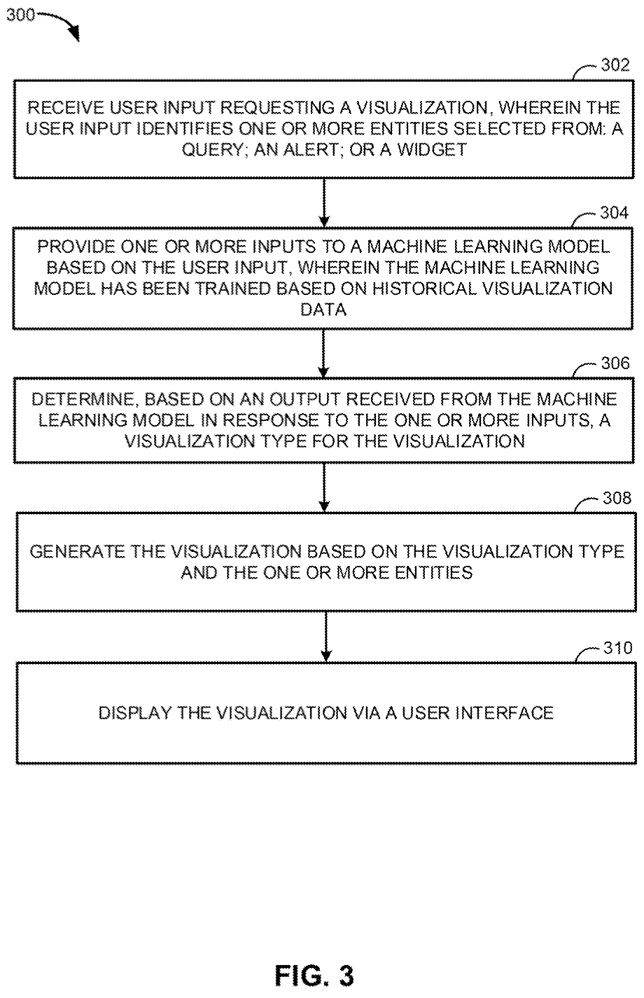

FIG. 3 depicts example operations 300 for self-adjusting data visualization. For example, operations 300 may be performed by management server 102 of FIG. 1.

Operations 300 begin at step 302, where user input requesting a visualization is received, the input identifying one or more entities selected from: a query; an alert; or a widget. The user input may, for example, be drag and drop input or another method of selection. In some embodiments, a user interface includes one panel from which entities can be selected and another panel (e.g., a dashboard) to which entities are added, and in which visualizations are displayed based on the selections.

At step 304, one or more inputs are provided to a machine learning model based on the user input, wherein the machine learning model has been trained based on historical visualization data. For example, one or more features may be extracted from the one or more entities selected by the user, and the one or more features may be provided as inputs to the trained machine learning model. The one or more features may, for instance, indicate one or more attributes of data included in the one or more entities.

At step 306, a visualization type is determined for the visualization based on an output received from the machine learning model in response to the one or more inputs. For example, the machine learning model may output an indication of a widget type to use for visualizing the selected one or more entities. If more than one entity was selected, the output from the model may also indicate whether the selected entities should be visualized in a single widget or in multiple widgets of one or more widget types.

At step 308, the visualization is generated based on the visualization type and the one or more entities. For example, one or more widgets may be generated to visualize the one or more entities.

At step 310, the visualization is displayed via a user interface. In some embodiments, the user is presented with the visualization and/or information about the visualization to confirm and/or provide feedback such as modifications. For example, the user may be presented with an indication that a single bar chart is recommended for visualizing the one or more entities, and may provide input confirming the recommendation or identifying one or more alternate widget types for the visualization. Furthermore, the user may be enabled to select additional entities to be visualized in the same user interface, such as by dragging and dropping the additional entities onto a dashboard. Thus, the user may be able to view a plurality of widgets with visualizations of subsets of data within the same user interface screen.

FIG. 4 illustrates an example screen 400 of a user interface for self-adjusting data visualization. For example, screen 400 may be provided by user interface 110 of FIG. 1.

Screen 400 comprises a panel 410 for creating a dashboard 430. Panel 410 comprises user interface components for selecting entities, such as queries, alerts, and existing widgets, for visualization within dashboard 430.

User interface component 412 allows a user to search for entities, such as using keywords and other criteria. At user interface components 414, 416, and 418, panel 410 shows how many queries, alerts, and existing widgets, respectively, are available to be selected. In some instance, selecting user interface component 414, 416, or 418 causes either queries, alerts, or existing widgets to be displayed within panel 410 for selection.

User interface components 420, 422, 424, and 426 represent entities that can be selected. For example, user interface component 420 represents a query for data indicating log volume for hosts, and includes descriptive text indicating that results of the query reveal that “a root file system has reached its resource pool limit,” and that “various administrative actions” can be taken. A user may select user interface components 420, 422, 424, and/or 426, such as by selecting check boxes within or near the components or by providing drag and drop input. For example, user interface component 420 may be dragged and dropped onto dashboard 430.

Dashboard 430 includes a user interface component 432 in which a name of the dashboard is displayed, and which includes controls for editing or deleting the dashboard. Dashboard 430 further includes user interface components 434 and 436 for, respectively, canceling and saving changes made to dashboard 430 (e.g., when in edit mode).

Dashboard 430 comprises a widget 438, which includes a visualization of the query represented by user interface component 420. Widget 438 includes an area graph represented as a line plot representing log volume of one or more hosts in gigabytes over the last fifteen minutes. For example, widget 438 may have been generated in response to user interface component 420 being dragged and dropped onto dashboard 430. Features of the query represented by user interface component 420 may have been provided as inputs to a trained machine learning model, and an output from the model in response to the inputs may have indicated that a line plot area graph was to be used to visualize the query.

User interface component 440 generally allows a user to edit widget 438, such as by changing the way the data retrieved by the query is visualized and/or which subsets of the data should be represented in the visualization. The user may, for example, change the widget type within user interface component 440, which may cause widget 438 to be modified accordingly.

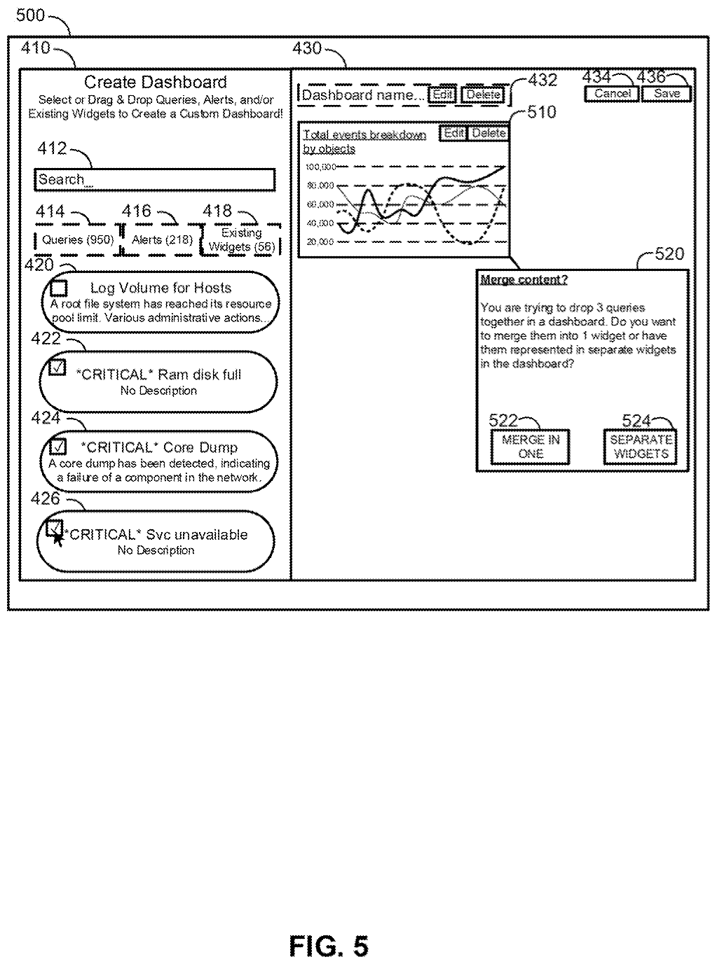

FIG. 5 depicts another example screen 500 of a user interface for self-adjusting data visualization. For example, screen 500 may be provided by user interface 110 of FIG. 1.

Screen 500 includes panel 410 and dashboard 430 of FIG. 4. However, while only one user interface component 420 was dragged and dropped onto dashboard 420 in screen 400, in screen 500 multiple user interface components 422, 424, and 426 have been selected by the user by selecting checkboxes.

Widget 510 is generated within dashboard 430 in response to the selection of user interface components 422, 424, and 426, and includes a single line plot area graph representing the three queries corresponding to user interface components 422, 424, and 426. For example, the machine learning model may have been provided with features of the three queries as inputs, and may have output an indication to visualize the three queries in a single widget with a line plot area graph.

User interface component 520 notifies the user that 3 separate queries have been added together in the dashboard, and provides the user with the option of merging them into a single widget (e.g., as shown in widget 510) or visualizing them in separate widgets. Selecting user interface component 522 may cause widget 510 to remain as shown, while selecting 524 may cause widget 510 to be replaced with three separate widgets, each representing a separate one of the three queries (e.g., as a separate line plot area graph).

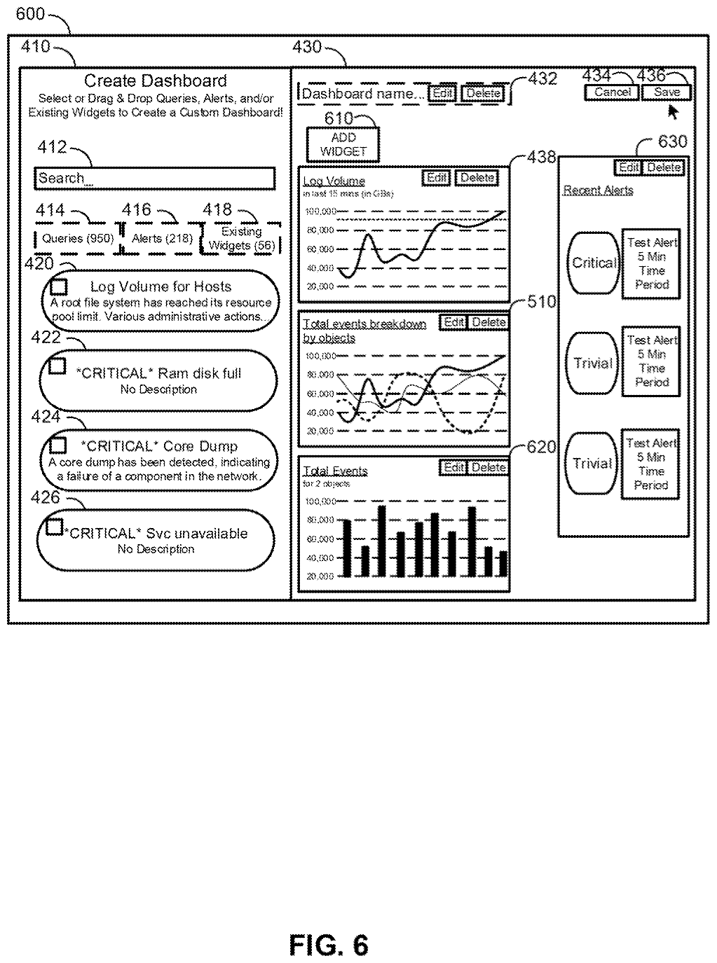

FIG. 6 depicts illustrates another example screen 600 of a user interface for self-adjusting data visualization. For example, screen 600 may be provided by user interface 110 of FIG. 1.

Screen 600 includes panel 410 and dashboard 430 of FIGS. 4 and 5. Furthermore, screen 600 includes widgets 438 of FIG. 4 and widget 510 of FIG. 5 within dashboard 430.

Screen 600 further includes widget 620 and 630, which may, for example, represent existing widgets that were selected from panel 410 for inclusion within dashboard 430. As shown, dashboard 430 includes a plurality of widgets 438, 510, 620, and 630 within a single view for convenient data analysis. The user may be able to edit, move, resize, and otherwise modify aspects of all widgets shown within dashboard 430.

Furthermore, user interface component 610 may allow the user to add additional widgets to dashboard 430 (e.g., as an alternative to selecting additional entities from panel 410). For example, selecting user interface component 610 may cause a list of existing widgets to be displayed for selection.

It is noted that the user interface components, widgets, and other aspects depicted and described with respect to FIGS. 4-6 are included as examples, and alternative, additional, or fewer components, widgets, and the like may be utilized with techniques described herein.

The various embodiments described herein may employ various computer-implemented operations involving data stored in computer systems. For example, these operations may require physical manipulation of physical quantities—usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and/or the like.

One or more embodiments of the present invention may be implemented as one or more computer programs or as one or more computer program modules embodied in one or more computer readable media. The term computer readable medium refers to any data storage device that can store data which can thereafter be input to a computer system—computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers each including an application and its dependencies. Each OS-less container runs as an isolated process in userspace on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

What is claimed is:

1. A method of data visualization, comprising:
receiving user input requesting a visualization, wherein the user input identifies one or more entities selected from: a query; an alert; or a widget;
providing one or more inputs to a machine learning model based on the user input, wherein the machine learning model has been trained based on historical visualization data;
determining, based on an output received from the machine learning model in response to the one or more inputs, a visualization type for the visualization;
generating the visualization based on the visualization type and the one or more entities; and
displaying the visualization via a user interface.

2. The method of claim 1, wherein the user input requesting the visualization comprises one or more of:
selecting the one or more entities from a first portion of the user interface; or
dragging and dropping the one or more entities from the first portion of the user interface onto a second portion of the user interface.

3. The method of claim 1, wherein providing the one or more inputs to the machine learning model based on the user input comprises determining one or more features of the one or more entities and providing the one or more features as the one or more inputs to the machine learning model.

4. The method of claim 1, wherein the one or more entities comprise two or more entities, and wherein the visualization type comprises one of:
a single visualization for all of the two or more entities; or
a plurality of separate visualizations for the two or more entities.

5. The method of claim 1, further comprising receiving additional user input approving or denying the visualization type.

6. The method of claim 1, further comprising:
receiving additional user input requesting an additional visualization, wherein the additional user input identifies an additional one or more entities; and
displaying the additional visualization and the visualization together in a screen of the user interface.

7. The method of claim 1, wherein the one or more entities comprise text-based data.

8. A system for data visualization, comprising:
at least one memory; and
at least one processor coupled to the at least one memory, the at least one processor and the at least one memory configured to:
receive user input requesting a visualization, wherein the user input identifies one or more entities selected from: a query; an alert; or a widget;
provide one or more inputs to a machine learning model based on the user input, wherein the machine learning model has been trained based on historical visualization data;
determine, based on an output received from the machine learning model in response to the one or more inputs, a visualization type for the visualization;
generate the visualization based on the visualization type and the one or more entities; and
display the visualization via a user interface.

9. The system of claim 8, wherein the user input requesting the visualization comprises one or more of:
selecting the one or more entities from a first portion of the user interface; or
dragging and dropping the one or more entities from the first portion of the user interface onto a second portion of the user interface.

10. The system of claim 8, wherein providing the one or more inputs to the machine learning model based on the user input comprises determining one or more features of the one or more entities and providing the one or more features as the one or more inputs to the machine learning model.

11. The system of claim 8, wherein the one or more entities comprise two or more entities, and wherein the visualization type comprises one of:
a single visualization for all of the two or more entities; or
a plurality of separate visualizations for the two or more entities.

12. The system of claim 8, wherein the at least one processor and the at least one memory are further configured to receive additional user input approving or denying the visualization type.

13. The system of claim 8, wherein the at least one processor and the at least one memory are further configured to:
receive additional user input requesting an additional visualization, wherein the additional user input identifies an additional one or more entities; and
display the additional visualization and the visualization together in a screen of the user interface.

14. The system of claim 8, wherein the one or more entities comprise text-based data.

15. A non-transitory computer-readable medium storing instructions that, when executed by one or more processors, cause the one or more processors to:
receive user input requesting a visualization, wherein the user input identifies one or more entities selected from: a query; an alert; or a widget;
provide one or more inputs to a machine learning model based on the user input, wherein the machine learning model has been trained based on historical visualization data;
determine, based on an output received from the machine learning model in response to the one or more inputs, a visualization type for the visualization;
generate the visualization based on the visualization type and the one or more entities; and
display the visualization via a user interface.

16. The non-transitory computer-readable medium of claim 15, wherein the user input requesting the visualization comprises one or more of:
selecting the one or more entities from a first portion of the user interface; or
dragging and dropping the one or more entities from the first portion of the user interface onto a second portion of the user interface.

17. The non-transitory computer-readable medium of claim 15, wherein providing the one or more inputs to the machine learning model based on the user input comprises determining one or more features of the one or more entities and providing the one or more features as the one or more inputs to the machine learning model.

18. The non-transitory computer-readable medium of claim 15, wherein the one or more entities comprise two or more entities, and wherein the visualization type comprises one of:
a single visualization for all of the two or more entities; or
a plurality of separate visualizations for the two or more entities.

19. The non-transitory computer-readable medium of claim 15, wherein the instructions, when executed by the one or more processors, further cause the one or more processors to receive additional user input approving or denying the visualization type.

20. The non-transitory computer-readable medium of claim 15, wherein the instructions, when executed by the one or more processors, further cause the one or more processors to:
receive additional user input requesting an additional visualization, wherein the additional user input identifies an additional one or more entities; and
display the additional visualization and the visualization together in a screen of the user interface.
